(19) United States
(12) Patent Application Publication
(10) Pub. No.: US 2024/0112185 A1
(43) Pub. Date: Apr. 4, 2024

(54) BLOCKCHAIN-BASED MYDATA TRANSACTION METHOD AND DEVICE

(71) Applicant: Jong Hyun KIM, Seoul (KR)

(72) Inventor: Jong Hyun KIM, Seoul (KR)

(21) Appl. No.: 18/475,909

(22) Filed: Sep. 27, 2023

(30) Foreign Application Priority Data
Sep. 30, 2022 (KR) 10-2022-0125140

(51) Int. Cl. G06Q 20/40; G06Q 20/38; G06Q 30/0207

(52) U.S. Cl. CPC G06Q 20/401; G06Q 20/389; G06Q 30/0236

(57) ABSTRACT

A block-chain-based Mydata transaction method in a method of trading block-chain-based Mydata using at least one processor according to embodiment of present invention comprises a transmission step of sending a Mydata download request to the data providing company, a download step of downloading the Mydata from the data providing company, a storage step of storing the downloaded Mydata in the form of a block-chain-based DID (Decentralized Identifier), a receiving step of receiving a Mydata purchase request from a data purchasing company and a providing step of providing Mydata stored with the DID to the data purchasing company in response to the Mydata purchase request.

### CROSS REFERENCE TO RELATED APPLICATIONS

This application claims priority based on Korean Patent Application No. 10-2022-0125140 filed Sep. 30, 2022, the entire disclosure of which is incorporated herein by reference.

### TECHNICAL FIELD

The present invention relates to a block-chain-based Mydata transaction method and device. More specifically, it concerns an invention that allows users, who own Mydata, to voluntarily or actively provide data directly to data purchasing companies and receive appropriate compensation.

### BACKGROUND ART

As the transition to an information society progresses rapidly, a data-based digital economy in which not only existing physical products or services but also data itself becomes the subject of transaction is becoming active.

Companies can purchase raw data such as observations and measurements, processed data, and databases that systematically produce, collect, and accumulate them through data exchanges and use them for corporate service development and data analysis.

Meanwhile, Mydata is a concept that defines the owner of financial data, such as bank account and credit card usage details, as the individual user rather than a financial company. It will be enacted in August 2020 due to the revision of the three data laws (Personal Information Protection Act, Credit Information Act, and Information and Communications Network Act). Starting in January, businessman can use Mydata with the agreement of individual users.

However, in the conventional data trading system, trust in the platform and transaction parties is not guaranteed, so there is a disadvantage in that Mydata cannot be purchased directly from the user.

Therefore, businessman wishing to purchase Mydata obtain Mydata through an organization that holds Mydata with the consent of the user.

Recently, the Mydata project has emerged, which integrates data to third parties through the right to request personal data transmission.

For example, trading platforms that mediate Mydata holders and Mydata purchasing companies are emerging.

However, while the demand for Mydata operators has increased to provide personalized services by integrating personal data in one place, the benefits provided to consumers who provide data are insufficient, making it difficult to spread Mydata.

### DISCLOSURE

### Technical Problem

The conventional Mydata transaction system has a centralized structure, so the administrator has all power and authority, so the data transaction system can be the target of a single point attack, and there is a problem that the user who is the owner of Mydata cannot directly determine to sell Mydata.

Therefore, the block-chain-based Mydata transaction method and device according to one embodiment is an invention designed to solve the problems described above. Specifically, the purpose of the present invention is to build a virtuous cycle transaction system in which individual users actively provide their data and receive compensation, which is an essential element in revitalizing Mydata based on block-chain in which individual users.

In addition, according to various embodiments of the present invention, the block-chain-based Mydata transaction method and device allows users to directly provide their information, and relieves discomfort thereby providing Mydata indirectly through consent to provision to a third party, etc.

### Technical Solution

A block-chain-based Mydata transaction method in a method of trading block-chain-based Mydata using at least one processor according to embodiment of present invention comprises a transmission step of sending a Mydata download request to the data providing company, a download step of downloading the Mydata from the data providing company, a storage step of storing the downloaded Mydata in the form of a block-chain-based DID (Decentralized Identifier), a receiving step of receiving a Mydata purchase request from a data purchasing company and a providing step of providing Mydata stored with the DID to the data purchasing company in response to the Mydata purchase request.

The providing step further comprises a step of receiving input from a user selecting additional information; and a step of providing the selected additional information together with the stored Mydata.

The additional information includes information about whether the user wish to purchase a new product or service.

The additional information includes information about whether the user consent to receive marketing.

The data providing company includes at least one of hospital, shopping mall, financial company, or school.

A block-chain-based Mydata transaction device according to embodiment of present invention comprises a communication module that supports communication connections between external electronic devices and a user device, an electronic wallet with block-chain application that stores user's Mydata, user-defined currency, or virtual currency, a memory to store instructions and a processor configured to send a Mydata download request to a data providing company, download the Mydata from the data providing company, store the downloaded Mydata as a block-chain-based DID (Decentralized Identifier), and receive a Mydata purchase request from a data purchasing company and provide the Mydata stored in the DID to the data purchasing company in response to the Mydata purchase request.

The processor is configured to receive input for selecting additional information from the user and provide the selected additional information together with the stored Mydata.

### Advantageous Effects

The block-chain-based Mydata transaction method and device according to an embodiment of the present invention, it has an effect establishing a system in which users can directly store their Mydata through a user device and selectively provide their Mydata to data purchasing companies.

In addition, according to various embodiments of the present invention, the present invention has the advantage of helping to establish a virtuous data cycle system and utilize data by providing appropriate compensation to users for providing data.

### BRIEF DESCRIPTION OF DRAWINGS

FIG. 1 is a diagram illustrating a block-chain-based Mydata transaction system according to various embodiments.

FIG. 2 is a flowchart showing the operation of a block-chain-based Mydata transaction system according to various embodiments.

FIG. 3 is a diagram illustrating an example of downloading Mydata from a data providing company according to various embodiments.

FIG. 4 is a diagram showing various organizations that utilize Mydata according to various embodiments.

FIG. 5 is a diagram illustrating a UI screen for trading Mydata on the user device, according to various embodiments.

FIG. 6 is a diagram illustrating a method by which a data purchasing company supports marketing, according to various embodiments.

FIG. 7 is a diagram illustrating a method by which a data purchasing company supports marketing, according to various embodiments.

FIG. 8 is a diagram illustrating a method by which the user device transmits content, according to various embodiments.

FIG. 9 is a block diagram illustrating components of the user device according to various embodiments.

FIG. 10 is a flowchart showing a method of trading block-chain-based Mydata in the user device, according to various embodiments.

### MODES OF THE INVENTION

Hereinafter, embodiments according to the present invention will be described with reference to the accompanying drawings.

In adding reference numbers to each drawing, it should be noted that the same components have the same numerals as much as possible even if they are displayed on different drawings. In addition, in describing an embodiment of the present invention, if it is determined that a detailed description of a related known configuration or function hinders understanding of the embodiment of the present invention, the detailed description thereof will be omitted.

In addition, embodiments of the present invention will be described below, but the technical idea of the present invention is not limited or limited thereto and can be modified and implemented in various ways by those skilled in the art.

In addition, terms used in this specification are used to describe embodiments and are not intended to limit and/or limit the disclosed invention. Singular expressions include plural expressions unless the context clearly dictates otherwise.

In this specification, terms such as “include”, “comprise” or “have” are intended to designate that there is a feature, number, step, operation, component, part, or combination thereof described in the specification, but one or the existence or addition of more other features, numbers, steps, operations, components, parts, or combinations thereof is not excluded in advance.

In addition, throughout the specification, when a part is said to be “connected” to another part, this is not only the case where it is “directly connected”, but also the case where it is “indirectly connected” with another element in the middle. Terms including ordinal numbers, such as “first” and “second” used herein, may be used to describe various components, but the components are not limited by the terms.

Hereinafter, with reference to the accompanying drawings, embodiments of the present invention will be described in detail so that those skilled in the art can easily carry out the present invention. And to clearly explain the present invention in the drawings, parts irrelevant to the description are omitted.

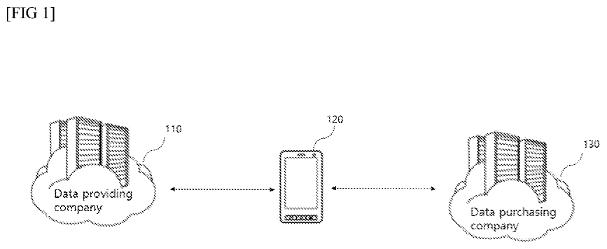

FIG. 1 is a diagram illustrating a block-chain-based Mydata transaction system according to various embodiments.

Referring to FIG. 1, the Mydata transaction system may include a data providing company 110, a user device 120, and a data purchasing company 130.

The data providing company 110 may be an organization or company that stores and manages at least information related to the user's Mydata, such as the user's personal financial information, medical treatment or prescription history, product purchase or payment history, and academic information.

For example, the data providing company 110 can include an organization or entity that is obligated to provide the user's Mydata in response to a request from the user, who is the information subject of the Mydata, to transmit Mydata, such as the user's personal grade information, to a third party or the principal.

According to one embodiment, the data providing company 110 may include one of a hospital, a shopping mall, a financial company, or a school.

It is not intended to limit the scope of the data providing company 110 to the organizations or companies listed above, and the scope of the data providing company 110 may be expanded to various organizations or companies according to various embodiments.

The user device 120 may be, for example, an electronic device that communicates with the data providing company 110 and the data purchasing company 130 according to the user's command and can store Mydata based on block-chain technology.

According to one embodiment, the user device 120 may include at least one of a smartphone, a tablet PC, a mobile phone, a video phone, an e-book reader, a desktop PC, a laptop PC, a netbook computer, a workstation, or a server.

In some embodiments, the user device 120 may be configured to include, for example, at least one of a television, a digital video disk (DVD) player, an audio device, a refrigerator, an air conditioner, a vacuum cleaner, an oven, a microwave oven, a washing machine, an air purifier, a set-top box, and a home automatic control panel, a security control panel, a media box, a game console, an electronic dictionary, an electronic key, a camcorder, or an electronic picture frame.

The user device 120 downloads Mydata from the data providing company 110, stores it as a block-chain-based DID (Decentralized Identifier), and sends Mydata to the data purchasing company 130 according to the purchase request from the data purchasing company 130.

The data purchasing company 130 may be, for example, an institution or company that provides services or products by collecting the user's personal financial information, medical treatment or prescription history, product purchase or payment history, academic information, etc.

For example, the data purchasing company 130 may be an organization or company that purchases Mydata from users, analyzes Mydata, and provides personalized products or services.

According to one embodiment, the data purchasing company 130 may include one of a bank, a credit card company, an insurance company, a financial investment company, an asset management company, a hospital, a pharmaceutical company, an employer, or a tax agent.

This is not intended to limit the scope of the data purchasing company 130 to the institutions or companies listed above, and the scope of the data purchasing company 130 may be expanded to various organizations or companies according to various embodiments.

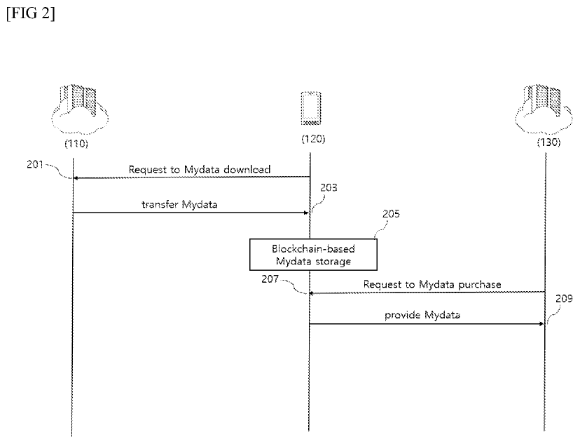

FIG. 2 is a flowchart showing the operation of a block-chain-based Mydata transaction system according to various embodiments.

Referring to FIG. 2, in operation 201, the user device 120 may request the data providing company 110 to download Mydata.

For example, the user device 120 may transmit a request to download Mydata for at least some of the user's personal financial information, medical treatment or prescription history, product purchase or payment history, and academic information to the data providing company 110.

In operation 203, the data providing company 110 may transmit all or part of the user's Mydata stored on the data providing company 110 server to the user device 120 in response to the user's Mydata download request.

In operation 205, the user device 120 may store Mydata received from the data providing company 110 in the form of a block-chain-based block-chain-based DID (Decentralized Identifier).

By utilizing DID-based authentication technology, the user device 120 can ensure the prevention of forgery and falsification of data directly provided by individuals and ensure trust in the data itself.

In operation 207, the data purchasing company 130 may transmit a purchase request message requesting data purchase to the user device 120.

Although not shown in the drawing, in some embodiments, it can also be done by passing it on that the user device 120 proposes selling Mydata to the data purchasing company 130, and after the data purchasing company 130 decides whether to purchase, it sends a purchase decision message to the user device.

In another embodiment, the user device 120 may sell Mydata by selecting the data purchasing company 130.

In operation 209, the user device 120 may transmit all or part of the stored Mydata in response to a purchase request message from the data purchasing company 130.

The user device 120 may provide all Mydata included in the purchase request message or select some of Mydata and provide it to the data purchasing company 130.

In another embodiment, additional information related to Mydata may be provided along with Mydata.

For example, information on whether you wish to purchase a product or service (e.g., signing up for an insurance product, etc.) can be provided to the data purchasing company 130 along with Mydata.

As another example, the user may provide the data purchasing company 130 with information on whether or not to consent to receive marketing (e.g., consultation rights, etc.).

Users can obtain various rewards from data purchasing companies 130 or trading platforms in return for providing Mydata.

For example, users can earn various rewards such as cash, points, mileage, and gift certificates.

If the user provides additional information to the data purchasing company 130, additional compensation may be obtained.

For example, when a user provides information to the data purchasing company 130 about whether he or she wishes to purchase a new product or service, the data purchasing company 130 can compensate the user with more cash, points, mileage, gift certificates, etc.

As another example, if the user agrees to receive marketing, the data purchasing company 130 may purchase various marketing tools, such as a 10-minute consultation ticket or a 20-minute consultation ticket, from the user and provide the user with corresponding compensation.

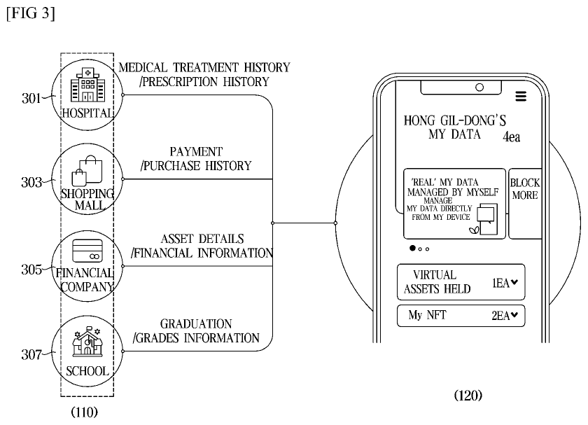

FIG. 3 is a diagram illustrating an example of downloading Mydata from a data providing company according to various embodiments.

The data providing company 110 may be an organization or company that stores and manages at least information related to the user's Mydata, such as the user's personal financial information, medical treatment or prescription history, product purchase or payment history, and academic information.

For example, the data providing company 110 is an organization or entity that is obligated to provide the user's Mydata in response to a request from the user, who is the information subject of the Mydata, to transmit Mydata, such as the user's personal grade information, to a third party or the principal. Can include companies.

According to one embodiment, the data providing company 110 may include one of a hospital 301, a shopping mall 303, a financial company 305, or a school 307.

This is not intended to limit the scope of the data providing company 110 to the organizations or companies listed above, and the scope of the data providing company 110 may be expanded to various organizations or companies according to various embodiments.

For example, the hospital 301 may retain information about the user's medical treatment history or prescription history, and when the user requests to download Mydata, the hospital 301 provides the medical treatment history or prescription history to the user device 120 in response.

In general, it is difficult to share treatment details and medical expense data between insurance companies and hospitals, and the complicated process of actual cost insurance, which requires manual submission of documents, can lead to consumers avoiding small claims, resulting in financial losses.

However, according to the present invention, such complicated and cumbersome procedures can be omitted, thereby preventing financial losses to consumers.

For example, the shopping mall 303 may hold information about the user's payment history or purchase history, and when the user requests to download Mydata, the shopping mall 303 provides the payment history or purchase history to the user device 120 in response.

Based on this, the data purchasing company 130 can analyze the user's consumption tendencies/patterns and perform user-tailored marketing.

For example, the financial company 305 may hold the user's asset details or financial information, and when the user requests Mydata download, the financial company 305 may transmit the asset details or financial information to the user device 120 in response.

For example, the school 307 may hold the user's graduation information or grade information, and when the user requests to download Mydata, the school 307 may transmit the graduation information or grade information to the user device 120 in response.

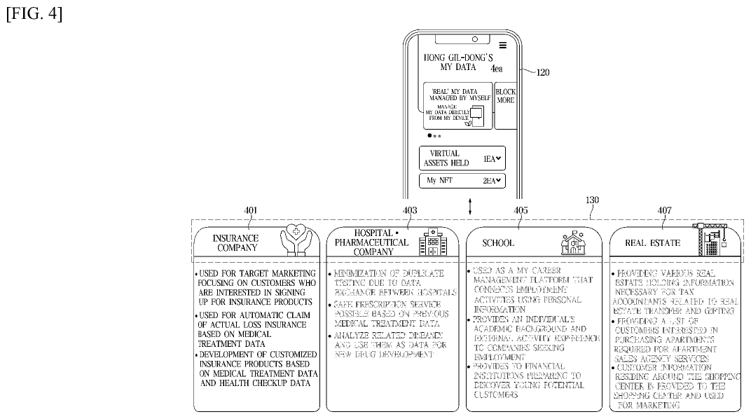

FIG. 4 is a diagram showing various organizations that utilize Mydata according to various embodiments.

According to one embodiment, the data purchasing company 130 may include one of a bank, a credit card company, an insurance company, a financial investment company, an asset management company, a hospital, a pharmaceutical company, an employer, or a tax agent. Referring to FIG. 4, it shows insurance companies 401, hospitals and pharmaceutical companies 403, schools 405, and real estate 407.

For example, the insurance company 401 can purchase Mydata focusing on customers who are interested in signing up for an insurance product and use it for target marketing.

As another example, the user's Mydata can be used to automatically claim actual loss insurance based on medical treatment data.

In another embodiment, the user's Mydata can be utilized to develop customized insurance products based on medical treatment data and health examination data.

In the present invention, the pharmaceutical company 403 can utilize the user's Mydata to minimize duplicate tests due to data exchange between hospitals, for example.

In another embodiment, based on previous treatment data, the user's Mydata can be used to provide safe prescription services. In another embodiment, the user's Mydata may be used as data for developing new drugs by analyzing related diseases.

In the present invention, school 405 may mean, for example, academic information such as the user's graduation information or grade information.

For example, users can easily register academic information based on trust in the My Career management platform linked to employment activities.

In another embodiment, an individual's academic background and external activity experience may be provided to a company seeking employment.

As another example, a user may sell the user's academic information to a financial institution preparing to discover young potential customers.

In the present invention, real estate 407 may mean, for example, information related to a user's real estate. Users can provide information related to real estate, such as information related to real estate transfers and gifts, to tax agents, etc.

As another example, real estate agents or real estate sellers can use Mydata to secure a list of consumers interested in purchasing real estate.

As another example, Mydata can be used to secure information on customers living near a shopping mall and conduct marketing.

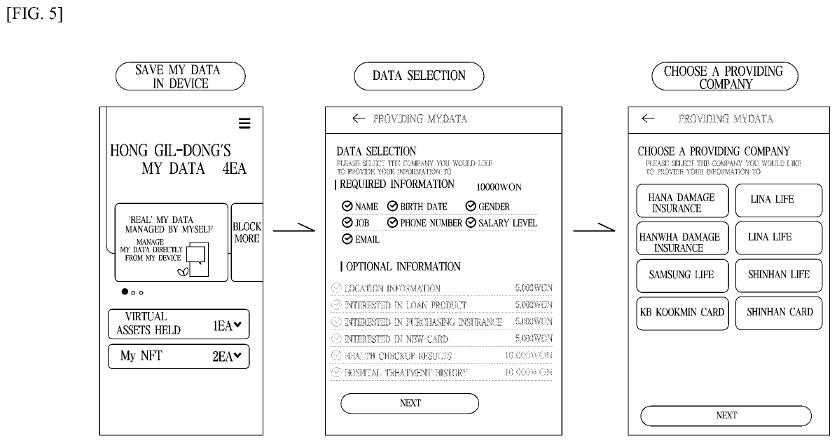

FIG. 5 is a diagram illustrating a UI screen for trading Mydata on the user device, according to various embodiments.

Referring to FIG. 5, at 501, the user device 120 may display Mydata held by the user.

The user's Mydata can be stored on the user's device as a block-chain-based DID. According to one embodiment, the Mydata storage platform may also store the user's virtual assets and/or Non-Fungible Tokens (NFTs).

At 503, the user device 120 may display a screen to select data to be provided to the data purchasing company 130.

For example, the data purchasing company 130 may provide Mydata essential information such as the user's name, date of birth, gender, occupation, phone number, salary level, and email address.

For example, the user may receive 10,000 won from the data purchasing company 130 in return for providing this required information.

The user may also provide additional information to the data purchasing company 130. For example, the user can select and provide information such as location information, interest in a loan product, interest in insurance, interest in a new card, health checkup results, hospital treatment history, etc.

At 505, the user device 120 may display a list of data purchasing companies 130. The user can select all or part of the data purchasing company 130 and provide the user's Mydata and additional information.

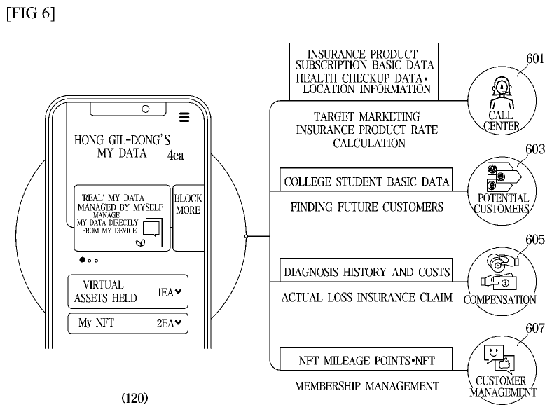

FIG. 6 is a diagram illustrating a method by which a data purchasing company supports marketing, according to various embodiments.

Referring to FIG. 6, the data purchasing company 130 uses the case of an insurance company as an example. If the user's Mydata, such as basic insurance product subscription data and health checkup data, is provided to the insurance company, target marketing can be facilitated.

For example, the call center 601 can calculate insurance product rates for target customers and carry out marketing efficiently.

If basic data of college students is provided to insurance companies, potential customers 603 can be discovered more efficiently.

For example, insurance companies can identify whether users are employed, when they are employed, etc. and conduct efficient marketing to discover future customers.

If the diagnosis history and costs are provided to the insurance company, the user can automatically receive compensation 605 without having to go through a separate and cumbersome process.

For example, it is difficult to share treatment details and medical expense data between insurance companies and hospitals, so the complex process of actual loss insurance, which involves submitting documents manually, can be omitted.

If mileage points, NFT information, etc. are provided to the insurance company, the insurance company can more easily manage customers 607.

For example, the insurance company can operate and market a membership system that utilizes mileage points, NFTs, etc.

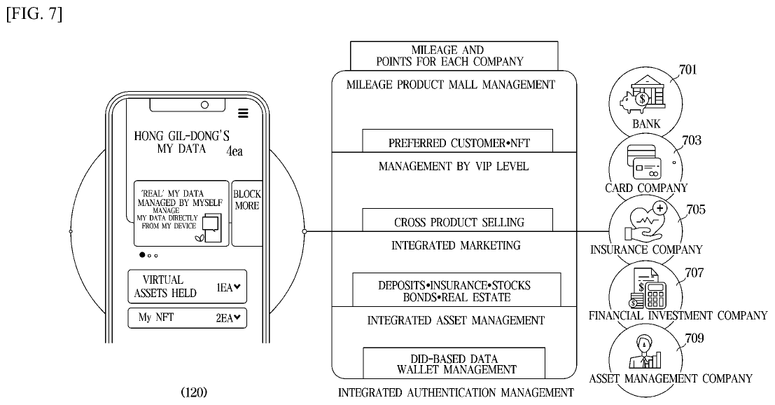

FIG. 7 is a diagram illustrating a method by which a data purchasing company supports marketing, according to various embodiments.

Referring to FIG. 7, the data purchasing company 130 uses the case of a financial group as an example. According to one embodiment, a financial group may have one of a bank 701, a credit card company 703, an insurance company 705, a financial investment company 707, or an asset management company 709 as a subsidiary.

Subsidiaries within a financial group can cross-sell by utilizing each other's customer database.

For example, mileage products can be managed using each company's mileage or points, or VIP levels can be managed using preferred customer or NFT information.

In addition, it can support integrated marketing through cross-product sales and support customers' integrated asset management or integrated authentication management.

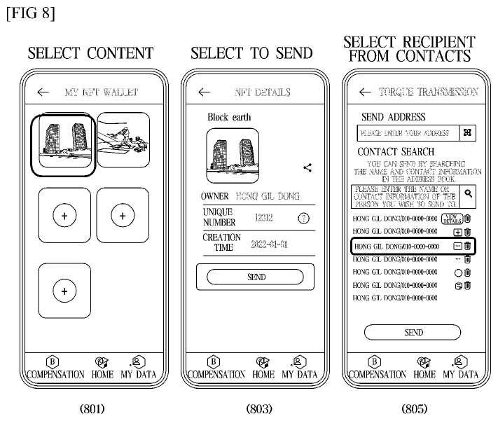

FIG. 8 is a diagram illustrating a method by which the user device transmits content, according to various embodiments.

Referring to FIG. 8, at 801, the user device 120 may receive an input for displaying and selecting content held by the user.

The user's Mydata can be stored on the user's device as a block-chain-based DID. According to one embodiment, the Mydata storage platform may also store the user's virtual assets and/or Non-Fungible Tokens (NFTs).

Here, the content may be any of Mydata, virtual assets, or NFT. The user can select one of the stored contents.

At 803, the user device 120 can determine whether to transmit the selected content and transfer the stored content by selecting a transmit button.

At 805, the user device 120 may receive an input for selecting a content recipient from contact information and deliver the content.

For example, in general, user need to know a complex 64-digit (hexadecimal) wallet address starting with Ox to transmit virtual assets, such as virtual content, but in the present invention, content can be transmitted based on the recipient's phone number information.

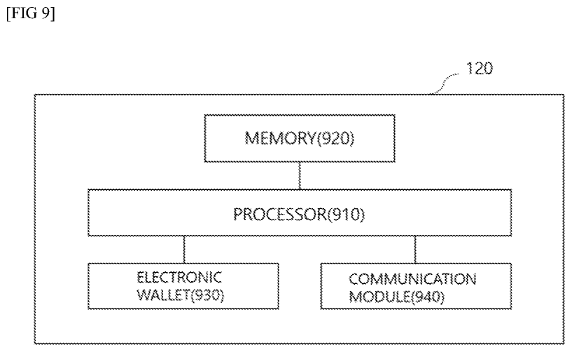

FIG. 9 is a block diagram illustrating a user device according to various embodiments.

Referring to FIG. 9, the user device 120 may include a processor 910, a memory 920, an electronic wallet 930, and a communication module 940. The components included in the user device 120 are not limited to this, and the user device 120 according to one embodiment may be implemented by further including other components or omitting some components.

The processor 910 may, for example, execute software to control at least one other component (e.g., hardware or software component) of the user device 120 connected to the processor 910, and process various data. Alternatively, calculations can be performed.

According to one embodiment, as at least part of data processing or computation, processor 910 stores commands or data received from another component (e.g., electronic wallet 930 or communication module 940) in memory 920. It is possible to load and process commands or data stored in the memory 920.

The memory 920 may store, for example, various data used by at least one component of the user device 120 (eg, the processor 910 or the electronic wallet 930).

Data may include, for example, input data or output data for software and instructions related thereto. Memory 920 may include volatile memory or non-volatile memory.

The electronic wallet 930 is a block-chain application that stores the user's Mydata, user-defined currency, and/or virtual currency, and provides block-chain-based Mydata services to the user by linking with the block-chain system and/or the data providing company 110.

For example, the communication module 940 may support establishment of a direct (e.g., wired) communication channel or wireless communication channel between the user device 120 and an external electronic device, and performance of communication through the established communication channel.

For example, the communication module 940 may support a communication connection between the user device 120 and the data providing company 110 and/or the data purchasing company 120.

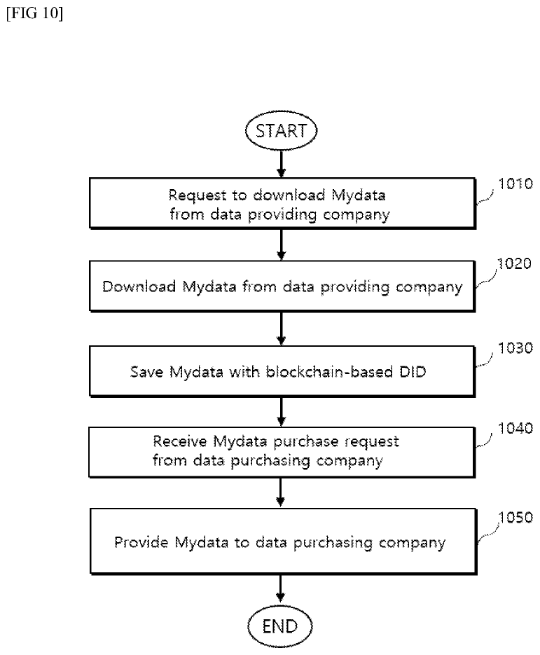

FIG. 10 is a flowchart showing a method of trading block-chain-based Mydata in the user device, according to various embodiments.

Referring to FIG. 10, in operation 1010, the user device 120 may request Mydata download from the data providing company 110 through the communication module 940.

For example, the user device 120 may transmit a request to download Mydata for at least some of the user's personal financial information, medical treatment or prescription history, product purchase or payment history, and academic information to the data providing company 110.

In operation 1020, the user device 120 may download the user's Mydata from the data providing company 110 through the communication module 940.

For example, the user device 120 may download at least some of the user's personal financial information, medical treatment or prescription history, product purchase or payment history, and academic information.

In operation 1030, the user device 120 may store the downloaded Mydata in the electronic wallet 930 as a block-chain-based Decentralized Identifier (DID).

The electronic wallet 930 is a block-chain application that stores the user's Mydata, user-defined currency, and/or virtual currency, and provides block-chain-based payment services to the user by linking with the block-chain system and/or the Mydata providing company 110.

In operation 1040, the user device 120 may receive a Mydata purchase request from the data purchasing company 130 through the communication module 940.

Meanwhile, although not shown in the drawing, in some embodiments, the user device 120 proposes selling Mydata to the data purchasing company 130, and the data purchasing company 130 decides whether to purchase it, and then delivers a message of the purchase decision to the user device.

In another embodiment, the user device 120 may sell Mydata by selecting the data purchasing company 130.

In operation 1050, the user device 120 may transmit all or part of the stored Mydata in response to a purchase request message from the data purchasing company 130.

The user device 120 may provide all Mydata included in the purchase request message or select some of Mydata and provide it to the data purchasing company 130.

In another embodiment, additional information related to Mydata may be provided along with Mydata.

For example, information on whether you wish to purchase a product or service (e.g., signing up for an insurance product, etc.) can be provided to the data purchasing company 130 along with Mydata.

As another example, the user may provide the data purchasing company 130 with information on whether or not to consent to receive marketing (e.g., consultation rights, etc.).

Users can obtain various rewards from data purchasing companies 130 or trading platforms in return for providing Mydata.

For example, users can earn various rewards such as cash, points, mileage, and gift certificates.

If the user provides additional information to the data purchasing company 130, the user may obtain additional compensation.

For example, when a user provides information to the data purchasing company 130 about whether he or she wishes to purchase a new product or service, the data purchasing company 130 can compensate the user with more cash, points, mileage, gift certificates, etc. there is.

As another example, if the user agrees to receive marketing, the data purchasing company 130 may purchase various marketing tools, such as a 10-minute consultation ticket or a 20-minute consultation ticket, from the user and provide the user with corresponding compensation.

So far, we have looked at the drawings in detail about the block-chain-based Mydata transaction method and device according to various embodiments of the present invention.

The block-chain-based Mydata transaction method and device according to an embodiment of the present invention has the effect of establishing a system in which users can directly store Mydata and provide it to data purchasing companys through a user device. In addition, there is an advantage that it can help build a virtuous data cycle system and utilize data by providing appropriate compensation to users for providing data.

At least a portion of the device (e.g., modules or functions thereof) or method (e.g., operations) according to various embodiments of the present invention can be implemented as a command stored in storage media stored in a computer-readable storage medium (e.g., in the form of a programming module).

When an instruction is executed by a processor, the processor can perform the function corresponding to the instruction.

The computer-readable storage medium may be, for example, the storage unit. At least a portion of the programming module may be implemented (eg, executed) by a processor.

At least a portion of a programming module may include, for example, modules, programs, routines, sets of instructions, or processes for performing one or more functions.

Examples of computer-readable recording media include magnetic media such as hard disks, floppy disks and magnetic tapes, optical media such as CD-ROMs and DVDs, and magnetic media such as floptical disks.—includes hardware devices specially configured to store and execute program instructions, such as magneto-optical media, and ROM, RAM, flash memory, and the like.

Examples of program instructions include high-level language codes that can be executed by a computer using an interpreter, as well as machine language codes such as those produced by a compiler.

The hardware devices described above may be configured to operate as one or more software modules to perform operations of various embodiments of the present invention, and vice versa.

A module or programming module according to various embodiments of the present invention may include at least one of the above-described components, some of them may be omitted, or may further include other additional components.

Operations performed by modules, programming modules, or other components according to various embodiments of the present invention may be executed in a sequential, parallel, iterative, or heuristic manner. Additionally, some operations may be executed in a different order, omitted, or other operations may be added.

In addition, the embodiments of the present invention disclosed in the specification and drawings are merely presented as specific examples to easily explain the technical content according to the embodiments of the present invention and to aid understanding of the embodiments of the present invention, and are not limited to the scope of the embodiments of the present invention. It is not intended to limit it.

Therefore, the scope of the various embodiments of the present invention should be interpreted as including all changes or modified forms derived based on the technical idea of the various embodiments of the present invention in addition to the embodiments disclosed herein.

1. A block-chain-based Mydata transaction method in a method of trading block-chain-based Mydatausing at least one processor comprising:
a transmission step of sending a Mydata download request to the data providing company;
a download step of downloading the Mydata from the data providing company;
a storage step of storing the downloaded Mydata in the form of a block-chain-based DID (Decentralized Identifier);
a receiving step of receiving a Mydata purchase request from a data purchasing company; and
a providing step of providing Mydata stored with the DID to the data purchasing company in response to the Mydata purchase request.

2. The block-chain-based Mydata transaction method according to claim 1,
wherein the providing step further comprises:
a step of receiving input from a user selecting additional information; and
a step of providing the selected additional information together with the stored Mydata.

3. The block-chain-based Mydata transaction method according to claim 2,
wherein the additional information includes information about whether the user wish to purchase a new product or service.

4. The block-chain-based Mydata transaction method according to claim 2,
wherein the additional information includes information about whether the user consent to receive marketing.

5. The block-chain-based Mydata transaction method according to claim 1,
wherein the data providing company includes at least one of hospital, shopping mall, financial company, or school.

6. A block-chain-based Mydata transaction device comprising:
a communication module that supports communication connections between external electronic devices and a user device;
an electronic wallet with block-chain application that stores user's Mydata, user-defined currency, or virtual currency;
a memory to store instructions; and
a processor configured to send a Mydata download request to a data providing company, download the Mydata from the data providing company, store the downloaded Mydata as a block-chain-based DID (Decentralized Identifier), and receive a Mydata purchase request from a data purchasing company and provide the Mydata stored in the DID to the data purchasing company in response to the Mydata purchase request.

7. The block-chain-based Mydata transaction device according to claim 6,
wherein the processor is configured to receive input for selecting additional information from the user and provide the selected additional information together with the stored Mydata.
